(19) United States
(12) Patent Application Publication
(10) Pub. No.: US 2016/0065514 A1
(43) Pub. Date: Mar. 3, 2016

(54) E-MAIL SERVER, VIDEO TERMINAL AND METHOD FOR SENDING VIDEO E-MAIL

(71) Applicant: HON HAI PRECISION INDUSTRY CO., LTD., New Taipei (TW)

(72) Inventors: CHUNG-HSUAN KUO, New Taipei (TW); SHENG-YU CHIANG, New Taipei (TW); CHIH-LUNG CHEN, New Taipei (TW)

(21) Appl. No.: 14/838,639

(22) Filed: Aug. 28, 2015

(30) Foreign Application Priority Data
Sep. 1, 2014 (TW) 103130084

(51) Int. Cl. H04L 12/58

(52) U.S. Cl. CPC H04L 51/10

(57) ABSTRACT

A video terminal configured to be connectable with an e-mail server and a communication server, the video terminal stores the text content input by a user, communicates with a plurality of terminals by the video communication, receives video of each terminal. The video terminal selects a edition format from a plurality of edition format, and transmits the text content, videos and the selected edition format to an e-mail server. A method of sending video e-mail applied in video terminal is also provided. An e-mail server and a method of sending video e-mail applied in e-mail server are also provided.

### CROSS-REFERENCE TO RELATED APPLICATIONS

This application claims priority to Taiwanese Patent Application No. 103130084 filed on Sep. 1, 2014, the contents of which are incorporated by reference herein.

### FIELD

The subject matter herein generally relates to e-mail communication technology.

### BACKGROUND

At present, e-mail communication system can provide text e-mail service, use camera and microphone to record video, and send the text e-mail and video to recipient. At present, a user can send video e-mail to one recipient or a user can send video e-mail to a plurality of recipients at the same time, but the e-mail communication system can't make a video e-mail together with a plurality of users at the same time. Recipient must read all the e-mails in sequence when receiving a plurality of e-mail with the same subject. It takes a lot of time to read the e-mails and the communication efficiency is not ideal.

### BRIEF DESCRIPTION OF THE DRAWINGS

Implementations of the present technology will now be described, by way of example only, with reference to the attached figures, wherein:

FIG. 1 is a diagram of an application environment of an e-mail server and a video terminal in accordance with one embodiment of the present disclosure.

FIG. 2 is a block diagram of an example Graphical User Interface (GUI) of a video terminal.

FIG. 3 is a block diagram of an example functional module of a video terminal.

FIG. 4 is another block diagram of an example GUI of a video terminal.

FIG. 5 is a block diagram of an example functional module of an e-mail server.

FIG. 6 is a flowchart of one example embodiment of a method of video terminal sending video e-mail in accordance with the present disclosure.

FIG. 7 is a flowchart of one example embodiment of a method of e-mail server sending video e-mail in accordance with the present disclosure.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

References to “an” or “one” embodiment in this disclosure are not necessarily to the same embodiment, and such references mean “at least one.”

In general, the word “module” as used hereinafter, refers to logic embodied in computing or firmware, or to a collection of software instructions, written in a programming language, such as, Java, C, or assembly. One or more software instructions in the modules may be embedded in firmware, such as in an erasable programmable read only memory (EPROM). The modules described herein may be implemented as either software and/or computing modules and may be stored in any type of non-transitory computer-readable medium or other storage device. Some non-limiting examples of non-transitory computer-readable media include CDs, DVDs, BLU-RAY, flash memory, and hard disk drives. The term “comprising”, when utilized, means “including, but not necessarily limited to”; it specifically indicates open-ended inclusion or membership in a so-described combination, group, series and the like.

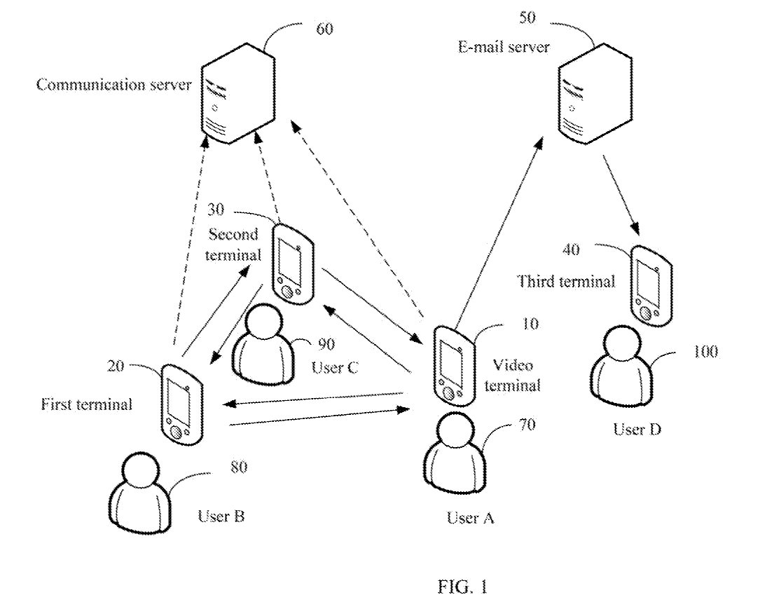

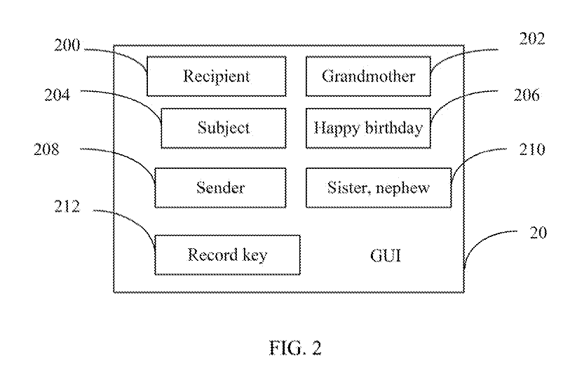

FIG. 1 is a diagram of an application environment of an e-mail server and a video terminal in accordance with one embodiment of the present disclosure. In the illustrated embodiment, a video terminal 10 connects with a communication server 60 and an e-mail server 50. The video terminal 10 also connects with a first terminal 20, a second terminal 30 and a third terminal 40 by network. User A 70 is owner of the video terminal 10, user B 80 is owner of the first terminal 20, user C 90 is owner of the second terminal 30, user D 100 is owner of the third terminal 40. Users A, user B, user C, user D can communicate to other through the terminals. User A 70 acting as main sender uses video terminal 10 to communicate with additional sender (such as user B, user C, user D) and make a video e-mail. User B 80 and user C 90 are additional senders. User A 70 open the video terminal 10 and a GUI shows on the video terminal 10, and the GUI is shown as FIG. 2.

In FIG. 2, the GUI 20 comprises menus for writing recipient 200, subject 204, and sender 208. In this embodiment, user A 70 writes the recipient 200 as “grandmother” 202, writes the subject 204 as “happy birthday” 206, writes sender 212 as “sister, nephew” 210, wherein user B 80 is sister, user C 90 is nephew, and user D 100 is grandmother. In FIG. 2, the GUI also comprises “record key” 212 for recording video of different senders. The video terminal 10 communicates with first terminal 80 and second terminal 90 by video communication, receives relevant videos from other terminals, makes a video e-mail by using received videos and sends the video e-mail to third terminal 40. The method for sending video e-mail is compatible with Simple Message Transfer Protocol (SMTP), and the video e-mail can be read by different terminals.

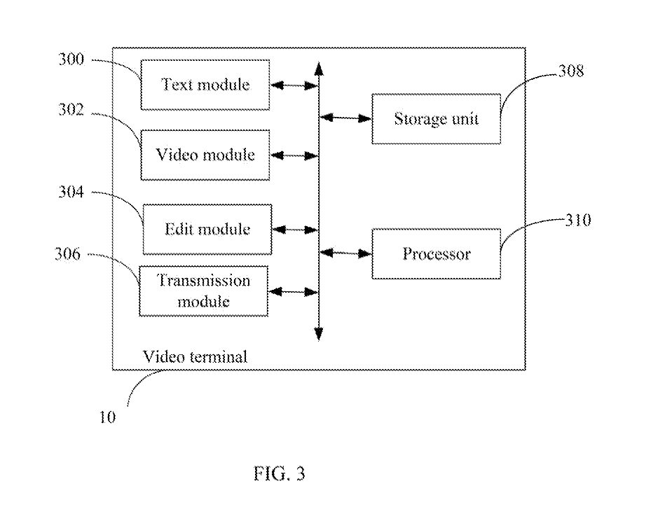

FIG. 3 is a block diagram of an example functional module of a video terminal. The one or more function modules can include computerized code in the form of one or more programs that are stored in the storage unit 308, and executed by the processor 310 to provide functions of the video terminal 10. The storage unit 308 can be a dedicated memory, such as an EPROM or a flash memory.

In an embodiment, the video terminal 10 includes a text module 300, a video module 302, and edition module 304 and transition module 306. The video terminal 10 applies in application environment shown in FIG. 1 in accordance with one embodiment of the present disclosure.

When user A 70 opens the video terminal 10 and inputs text content to edit a video e-mail shown as FIG. 2, the text module 300 stores the text content input by the main sender (user A 70), the video module 302 calls to sister (user B 80) and nephew (user C 90) and starts a video communication with user B 80 and user C 90. The first terminal 20 and second terminal 30 shows a calling GUI in each terminal. The calling GUI comprises acceptance key and rejection key. The video terminal 10 communicates with the first terminal 20 and second terminal 30 through communication server when the first terminal 20 and second terminal 30 selects acceptance key. The communication server provides instant communication for the video terminal 10, the first terminal 20 and second terminal 30.

When user A 70 presses the record key shown in FIG. 2, the video module 302 sends control commander to the communication server to make the video terminal 10, the first terminal 20 and second terminal 30 to start recording video at the same time. For example, the video terminal 10, the first terminal 20 and second terminal 30 starts record instant video of singing a happy birthday song at the same time.

The video module 302 receives the recorded video from the first terminal 20 and second terminal 30 transmitted by the communication server 60, and the video module 302 obtains the recorded video of the video terminal 10.

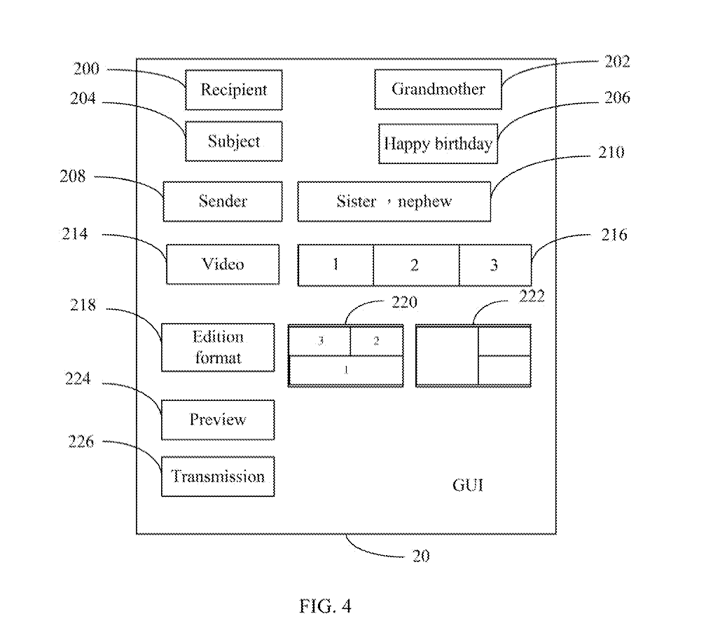

In FIG. 4, the GUI of video terminal 10 shows three videos 216 obtained from three terminals, and the GUI 20 also shows “video” label 214 and three videos 216, a plurality of different edition formats 218 of the three videos 216, wherein the edition format 218 comprises a plurality of squares, and different edition formats 218 shows squares in different sequence, for example edition format 220 and edition format 222. For example, there are three videos labeled with 1,2,3, user can select the first edition format 220 in FIG. 4 to edit three videos, three videos can be edited as follow:

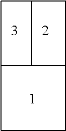

that is, the first edition format 220 stands for the video labeled with 3 plays before the video labeled with 2 and the video labeled with 1 plays after the video labeled with 2.

The transmission module 306 of the video terminal 10 sends the text content, video recorded by the main sender, video recorded by each additional sender and the selected edition format 218 to an e-mail server 50 after selecting a edition format from a plurality of edition formats 218. The video terminal 10 receives a video file from the e-mail server 50 and previews the video file by touching “preview” menu 224 and sends a transmission commander to the e-mail server 50 by touching “transmission ” menu 226.

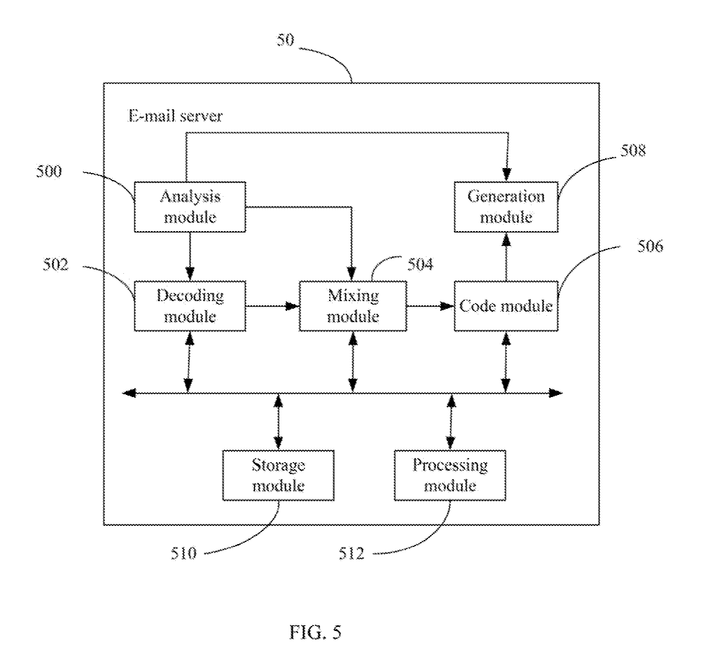

FIG. 5 is a block diagram of an example functional module of an e-mail server. The one or more function modules can include computerized code in the form of one or more programs that are stored in the storage module 510, and executed by the processing module 512 to provide functions of the e-mail server 50. The storage module 510 can be a dedicated memory, such as an EPROM or a flash memory. The e-mail server also comprises an analysis module 500, a decode module 502, a mixing module 504, a code module 506 and a generation module 508. The e-mail server 50 applies in application environment shown in FIG. 1 in accordance with one embodiment of the present disclosure.

The e-mail server 50 receives data message sent by video terminal, wherein the mail comprises text content and a plurality of video files and a edition format of the video files. The analysis module 500 of the e-mail server 50 separates text content from data message, separates video files from data message, and separates edition format from data message. The text content comprises recipient “grandmother”, sender “sister and nephew”, subject “happy birthday”. The analysis module 500 sends the text content to the generation module 508, sends the videos to decode module 502, and sends the edition format to the mixing module 504. The decode module 502 of the e-mail server 50 separates image file from each video file and decoding the separated audio file, and separates audio file from each video file and decoding the separated audio file. The decoding module 502 decodes the image file of each video, and decodes the audio file of each video, and sends the decoded image files and decoded audio files to the mixing module 504.

The mixing module 504 generates a mixing image file by editing image files according to the edition format receiving from the analysis module 500, and generates a mixing audio file by editing audio files according to the edition format receiving from the analysis module 500. The code module 506 codes the mixing image file and the mixing audio file and synchronizes the coded mixing image file and the coded mixing audio file to generate a mixing video file. The generation module 508 integrate the text content and the mixing video file to make a video e-mail. For example, making a “happy birthday song” mixing video by mixing the videos of user A, user B and user C, and the e-mail server 50 sends the mixing video to the video terminal 10, the transmission module 306 of the video terminal 10 receives the mixing video and previews the mixing video for user A 70.

The transmission module 306 sends confirmation message to the e-mail server when the user A selects a confirmation key. The e-mail server 50 receives the confirmation message and sends the video e-mail to third terminal 40 (user D 100 grandmother). The user D 100 grandmother can read the video e-mail by using third terminal 40.

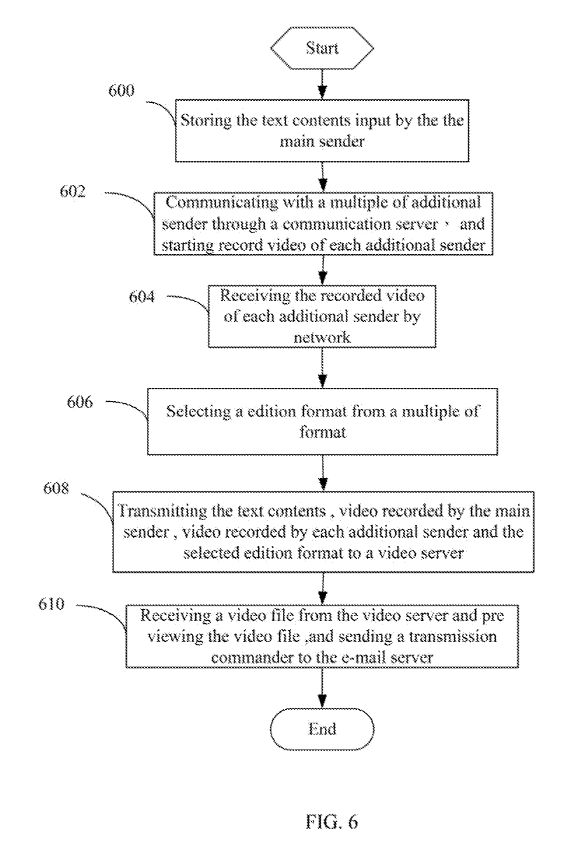

FIG. 6 is a flowchart of one example embodiment of a method of video terminal sending video e-mail in accordance with the present disclosure.

At block 600, the text module 300 stores the text content input by the main sender(user A 70), when user A 70 inputs text content to edit a video e-mail, wherein the text content comprises recipient “grandmother”, sender “sister and nephew”, subject “happy birthday”.

At block 602, the video module 302 calls to sister (user B 80) and nephew (user C 90) and stars a video communication with user B 80 and user C 90.

At block 604, when user A 70 press the record key shown in FIG. 2, the video module 302 sends control commander to the communication server to make the video terminal 10, the first terminal 20 and second terminal 30 to start recording video at the same time and receives the recorded videos from the first terminal 20 and second terminal 30 transmitted by the communication server 60, and the video module 302 obtains the recorded video of the video terminal 10.

At block 606, user A 70 selects a edition format 218 from a plurality of different edition formats 218 shown on the video terminal 10.

At block 608, the transmission module 306 of the video terminal 10 sends the text content, video recorded by the main sender, video recorded by each additional sender and the selected edition format to an e-mail server 50 after selecting a edition format from a plurality of edition format.

At block 610, the video terminal 10 receives a video file from the e-mail server 50 and previews the video file and sends a transmission commander to the e-mail server 50.

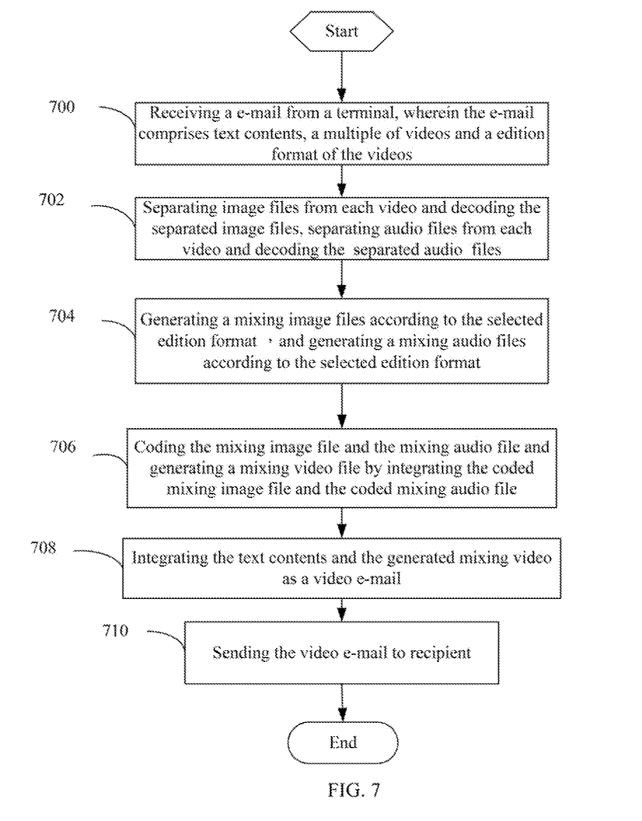

FIG. 7 is a flowchart of one example embodiment of a method of e-mail server sending video e-mail in accordance with the present disclosure.

At block 700, the e-mail server 50 receives data message sent by video terminal, wherein the mail comprises text content and a plurality of video files and a edition format for the video files.

At block 702, the analysis module 500 of the e-mail server 50 separates text content from the data message, separates video files from the data message, and separates edition format from the data message. The analysis module 500 sends the text content to the generation module 508, sends the videos to decode module 502, and sends the edition format to the mixing module 504. The decode module 502 of the e-mail server 50 separates image file from each video file and decoding the separated image file, and separates audio file from each video file and decoding the separated audio file. The decoding module 502 decodes the image file of each video, and decodes the audio file of each video, and sends the decoded image files and decoded audio files to the mixing module 504.

At block 704, the mixing module 504 generates a mixing image file by editing image files according to the edition format receiving from the analysis module 500, and generates a mixing audio file by editing audio files according to the edition format receiving from the analysis module 500.

At block 706, the code module 506 codes the mixing image file and the mixing audio file and synchronizes the coded mixing image file and the coded mixing audio file to generate a mixing video file.

At block 708, the generation module 508 integrates the text content and the mixing video file to make a video e-mail. For example, making a “happy birthday song” mixing video by mixing the video of user A, user B and user C, the e-mail server 50 sends the mixing video to the video terminal 10, the transmission module 306 of the video terminal 10 receives the mixing video and previews the mixing video for user A 70.

At block 710, the e-mail server 50 sends the video e-mail to third terminal 40 (user D 100 grandmother). The user D 100 grandmother can read the video e-mail by using third terminal 40.

The embodiments shown and described above are only examples. Many details are often found in the art such as the other features of a device and method for e-mail server or a video terminal. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, especially in matters of shape, size, and arrangement of the parts within the principles of the present disclosure, up to and including the full extent established by the broad general meaning of the terms used in the claims. It will therefore be appreciated that the embodiments described above may be modified within the scope of the claims.

What is claimed is:

1. An e-mail server in signal communication with a video terminal, the E-mail server comprising:
at least one processor;
a storage system; and
one or more programs that are stored in the storage system which when executed by the processor, cause the processor to:
receive a data message sent by the video terminal, wherein the data message comprises text content, a plurality of video files and an edition format of the video files;
separate each of the video files to obtain an image file and an audio file;
decode the image files and the audio files;
generate a mixing image file by editing the image files according to the edition format;
generate a mixing audio file by editing the audio files according to the edition format;
code the mixing image file and the mixing audio file;
generate a mixing video file by integrating the coded mixing image file and the coded mixing audio file; and
integrate the text content and the mixing video as a video e-mail.

2. The e-mail server of claim 1, wherein the processor further to:
send the video e-mail to the video terminal in order that the video terminal previews the video mail.

3. The e-mail server of claim 2, wherein the processor further to:
receive a transmission commander from the video terminal and sending the video terminal to recipient.

4. The e-mail server of claim 1, wherein the text content comprises recipient, subject, and sender.

5. A video terminal in signal communication with an e-mail server and a communication server, the video terminal comprising:
at least one processor;
a storage system; and
one or more programs that are stored in the storage system which when executed by the processor, cause the processor to:
store the text content input by a user;
communicate with a plurality of other terminals by video communication, and sending a record commander to the communication server to start recording video of each terminal;
receive the recorded video of each terminal;
select a edition format from a plurality of edition format; and
transmit the text content, videos and the selected edition format to an e-mail server.

6. The video terminal of claim 5, wherein the processor further to: receive a video file from the video server and previewing the video file, and send a transmission commander to the video server.

7. The video terminal of claim 5, wherein the edition format comprises a plurality of squares, and different edition format shows squares in different sequence.

8. The video terminal of claim 5, wherein the text content comprises recipient, subject, and sender.

9. A method for sending video e-mail, applied in an e-mail server in signal communication with a video terminal, the method comprising processes to:
receive a data message sent by the video terminal, wherein the data message comprises text content, a plurality of video files and an edition format of the video files;
separate each of the video files to obtain an image file and an audio file;
decode the image files and the audio files;
generate a mixing image file by editing the image files according to the edition format;
generate a mixing audio file by editing the audio files according to the edition format;
code the mixing image file and the mixing audio file;
generate a mixing video file by integrating the coded mixing image file and the coded mixing audio file; and
integrate the text content and the generated mixing video as a video e-mail.

10. The method of claim 9, further comprising processes to:
send the video e-mail to the video terminal in order that the video terminal previews the video mail.

11. The method of claim 10, further comprising processes to:
receive a transmission commander from the video terminal and sending the video terminal to recipient.

12. The method of claim 9, wherein the text content comprises recipient, subject, and sender.

13. A method of sending video e-mail, applied in a video terminal in signal communication with an e-mail server and a communication server, the method comprising processes to:
store the text content input by a user;
communicate with a plurality of other terminals by video communication, and sending a record commander to the communication server to start record video of each terminal;
receive the recorded video of each terminal;
select a edition format from a plurality of edition format; and
transmit the text content, videos and the selected edition format to an e-mail server.

14. The method of claim 13, further comprising processes to:
receive a video file from the video server and previewing the video file, and send a transmission commander to the video server.

15. The method of claim 13, wherein the edition format comprises a plurality of squares, and different edition format shows squares in different sequence.

16. The method of claim 13, wherein the text content comprises recipient, subject, and sender.
